(19) United States
(12) Patent Application Publication
(10) Pub. No.: US 2025/0197170 A1
(43) Pub. Date: Jun. 19, 2025

(54) WINCH MONITORING DEVICE AND CRANE

(71) Applicant: SUMITOMO HEAVY INDUSTRIES CONSTRUCTION CRANES CO., LTD., Tokyo (JP)

(72) Inventor: Daisuke ISHIDA, Obu-shi (JP)

(21) Appl. No.: 18/984,884

(22) Filed: Dec. 17, 2024

(30) Foreign Application Priority Data
Dec. 19, 2023 (JP) 2023-213583

(51) Int. Cl. B66C 13/18; B66D 1/40; G07C 5/10

(52) U.S. Cl. CPC B66C 13/18; B66D 1/40; G07C 5/10

(57) ABSTRACT

A winch monitoring device that monitors a state of a drum around which a rope is wound includes a detection unit configured to acquire detection data indicating a state of a two-dimensional region in the rope wound around the drum, in which, when a portion out of the rope wound around the drum is referred to as a wound rope portion, a portion that is separated from the wound rope portion and extends outward from the drum is referred to as an unwound rope portion, and a portion having a distance from the wound rope portion within a diameter of the rope out of the unwound rope portion is referred to as an unwound rope root portion, the two-dimensional region is set to a region not including a portion excluding the unwound rope root portion from the unwound rope portion.

### CROSS-REFERENCE TO RELATED APPLICATIONS

This application claims priority to Japanese Patent Application No. 2023-213583, filed on Dec. 19, 2023, which is incorporated by reference herein in its entirety.

### BACKGROUND

### Technical Field

Certain embodiments relate to a winch monitoring device and a crane.

### Description of Related Art

Related art discloses a winch monitoring device that performs quality determination of a winding state of a rope in relation to a winch of a crane. In the device, the rope wound around a drum of the winch is captured with a camera, and quality determination is performed based on a captured image.

### SUMMARY

According to an embodiment of the present invention, there is provided a winch monitoring device that monitors a state of a drum around which a rope is wound, the winch monitoring device including a detection unit configured to acquire detection data indicating a state of a two-dimensional region in the rope wound around the drum, in which, when a portion out of the rope wound around the drum is referred to as a wound rope portion, and a portion that is separated from the wound rope portion and extends outward from the drum is referred to as an unwound rope portion, the two-dimensional region is set to a region not including the unwound rope portion.

According to another embodiment of the present invention, there is provided a winch monitoring device that monitors a state of a drum around which a rope is wound, the winch monitoring device including a detection unit configured to acquire detection data obtained by detecting a state of the rope wound around the drum, and a control device configured to determine, when a portion out of the rope wound around the drum is referred to as a wound rope portion, and a portion that is separated from the wound rope portion and extends outward from the drum is referred to as an unwound rope portion, the state of the drum based on detection data excluding a portion indicating a state of the unwound rope portion out of the detection data.

According to still another embodiment of the present invention, there is provided a crane including the winch monitoring device.

### BRIEF DESCRIPTION OF THE DRAWINGS

FIGS. 1A and 1B are a side view and a plan view showing a crane according to Embodiment 1 of the present invention.

FIG. 2 is a diagram showing a configuration of a winch and a rope that is wound around a drum.

FIG. 3 is a block diagram showing a configuration of a monitoring device of Embodiment 1.

FIG. 4 is a diagram showing a detection region by a detection unit (camera) of Embodiment 1.

FIG. 5 is a diagram showing a detection region by a detection unit (camera) of Embodiment 2.

FIG. 6 is a flowchart illustrating a procedure of monitoring processing that is executed by a control device of Embodiment 2.

FIGS. 7A and 7B are diagrams showing a first example and a second example of disposition and a direction of a detection unit in Embodiments 3 and 4.

FIG. 8 is an enlarged view showing a periphery of the drum of the winch.

FIGS. 9A to 9C are diagrams showing disposition of a detection unit and a background wall of Embodiment 5, FIG. 9A is a perspective view, FIG. 9B is a rear view when the drum is viewed from the rear side, and FIG. 9C shows an example of a detected image of the detection unit (camera).

FIGS. 10A to 10C are diagrams showing disposition of a detection unit and a background wall of Embodiment 6, FIG. 10A is a perspective view, FIG. 10B is a rear view when the drum is viewed from the rear side, and FIG. 10C shows an example of a detected image of the detection unit (camera).

### DETAILED DESCRIPTION

As the above-described winch monitoring device, in a configuration in which quality determination is performed based on the captured image of the rope wound around the drum, sufficiently high determination accuracy may not be obtained. The rope wound around the drum includes a portion wound around the drum and a portion unwound from the drum. For the portion unwound from the drum, a position is not fixed, and a change in state such as vibration or slack is likely to occur. The present inventors have found that the portion unwound from the drum being included in the captured image causes deterioration of determination accuracy.

It is desirable to provide a winch monitoring device and a crane capable of monitoring a state of a drum of a winch with high accuracy.

Hereinafter, each embodiment of the present invention will be described in detail with reference to the drawings. In the present embodiment, each of the directions of front, rear, right, and left is represented with a direction from a base end to a tip end of a boom 13 when the boom 13 is lowered, out of a horizontal direction set as a “front side”. A vertical upper side and a vertical lower side when a crane 1 is provided on a horizontal plane are written as an “upper side” and a “lower side”, respectively.

### Embodiment 1

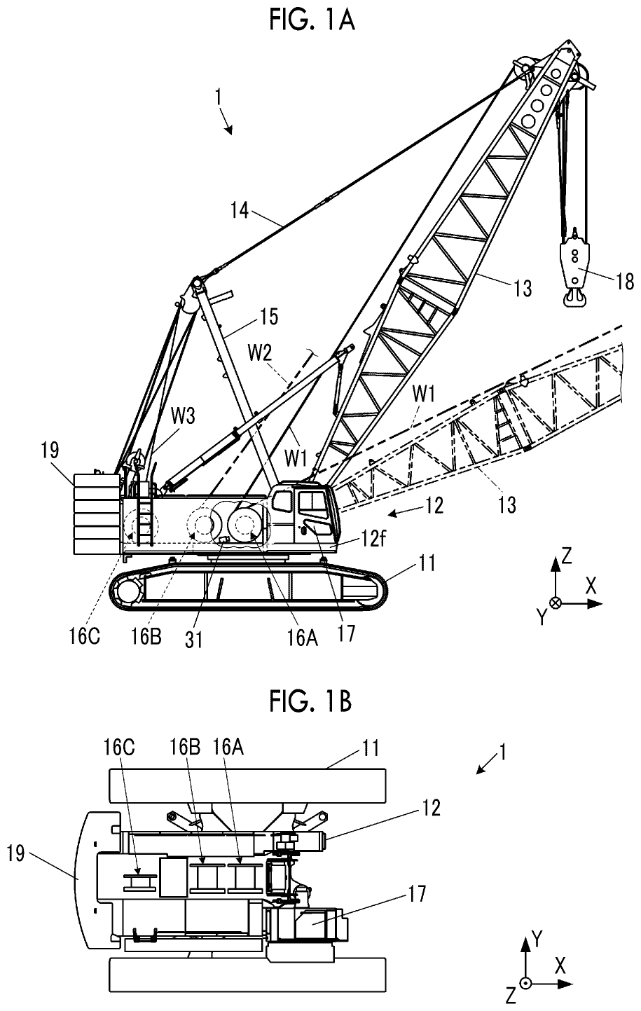

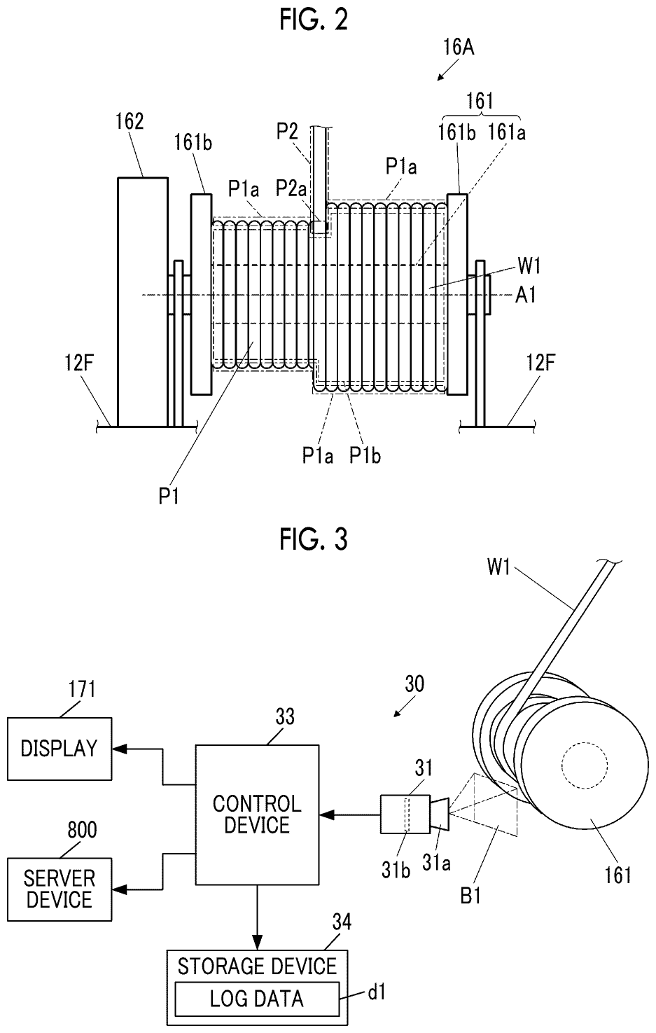

FIGS. 1A and 1B are a side view and a plan view showing a crane according to Embodiment 1 of the present invention. FIG. 1A shows a portion of a drum by virtually breaking a machine room. The lowered boom 13 is shown by an imaginary line. In FIG. 1B, the boom 13 and ropes W1 to W3 are not shown. FIG. 2 is a diagram showing a configuration of a winch 16A and a rope W1 wound around a drum 161. FIG. 3 is a block diagram showing a configuration of a monitoring device according to Embodiment 1 of the present invention.

A crane 1 of Embodiment 1 is a self-propelled crawler crane, and as shown in FIGS. 1A and 1B, includes a travelable lower traveling body 11, a rotating platform 12 rotatably supported by the lower traveling body 11, the boom 13 derrickably supported by the rotating platform 12, a mast 15 connected to the boom 13 via a pendant member 14, a plurality of winches 16A to 16C that wind and unwind a plurality of ropes W1 to W3, respectively, a cab 17 where a driving operation is performed by an operator, a suspending tool 18 that suspends a suspended cargo, and a counterweight 19 that is a weight for achieving a balance with a load of the suspended cargo. The crane 1 further includes a monitoring device 30 shown in FIG. 3.

The plurality of ropes W1 to W3 are, for example, wire ropes. The plurality of ropes W1 to W3 include the rope W1 for raising and lowering (changing a suspending position) the suspending tool 18, the rope W3 connected to the mast 15 to derrick the boom 13, and the rope W2 for raising and lowering an auxiliary suspending tool (not shown). A form in which the auxiliary suspending tool and the rope W2 are not used is applied to the crane 1 of FIGS. 1A and 1B.

As shown in FIG. 2, the winch 16A includes a drum 161, and a drive unit 162 that rotationally drives the drum 161. The drum 161 includes a body portion 161a around which the rope W1 is wound, and a pair of flange portions 161b provided on both sides of the body portion 161a. The winch 16A rotationally drives the drum 161 to wind and unwind the rope W1.

Other two winches 16B and 16C are configured similarly to the winch 16A.

The drive units 162 of the winches 16A to 16C are operated by an operation of the cab 17 or a remote operation, and the drums 161 of the winches 16A to 16C are rotationally driven, so that the ropes W1 to W3 are wound or unwound. As a result, the boom 13 is derricked, and the suspending tool 18 or the auxiliary suspending tool is raised or lowered.

### Description of Name of Each Portion of Rope

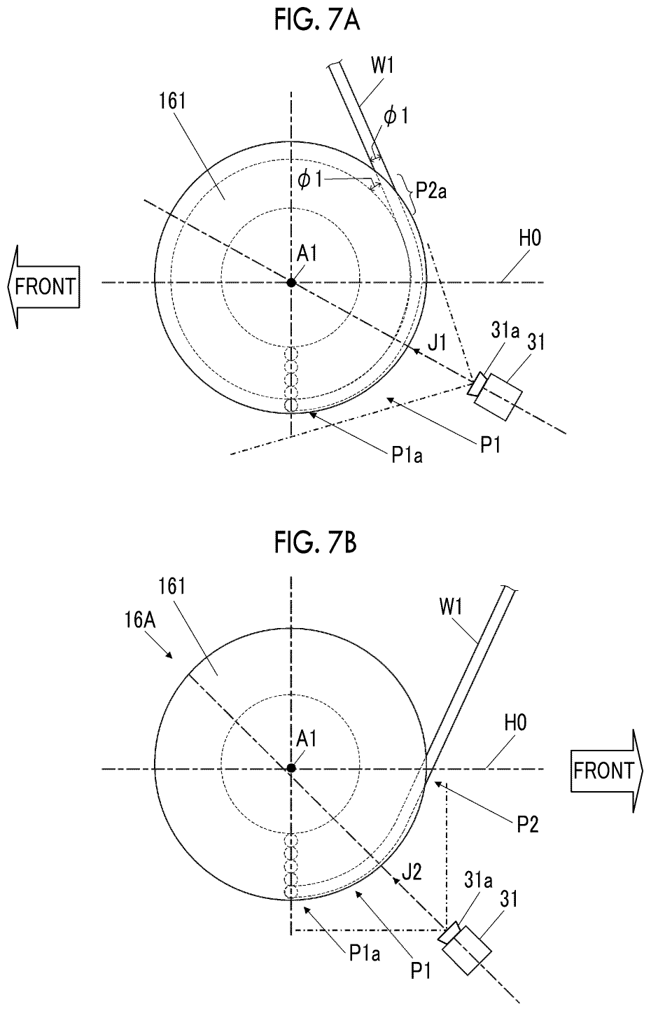

Here, a name of each portion of the rope W1 that is wound around the drum 161 will be described. The rope W1 that is wound around the drum 161 includes a wound rope portion P1 wound around the drum 161, and an unwound rope portion P2 that is separated from the wound rope portion P1 (or when there is no wound rope portion P1, the body portion 161a of the drum 161) and extends outward from the drum 161. The wound rope portion P1 includes, when viewed from a direction facing a rotation axis A1 of the drum 161, a ridge portion P1a that is equivalent to an edge of the wound rope portion P1 in a radial direction of the drum 161, and a swell portion P1b that is a portion other than the ridge portion P1a out of the wound rope portion P1. The unwound rope portion P2 includes an unwound rope root portion P2a (also see FIG. 7A) having a distance (minimum distance) from the wound rope portion P1 or the body portion 161a within a diameter q1 of the rope W1.

### Winch Monitoring Device

The monitoring device 30 monitors the state of each of the winches 16A to 16C. Hereinafter, a configuration for monitoring one winch 16A among the three winches 16A to 16C will be described. The configurations for monitoring other winches 16B and 16C are similar to the configuration for monitoring the winch 16A.

As shown in FIG. 3, the monitoring device 30 includes a detection unit 31 that detects a state of a two-dimensional region (written as a detection region B1) of the rope W1 wound around the drum 161, and a control device 33 that determines a state of the drum 161 based on detection data acquired by the detection unit 31. The two-dimensional region means a region having an area when projected onto a two-dimensional coordinate system. The detection data indicating the state of the two-dimensional region includes a two-dimensional camera video, a point cloud in an X-Y direction of a scanner such as light detection and ranging (LiDAR), or the like. Three-dimensional information that can be acquired by a stereo camera or the like also includes information for the two-dimensional region, and is equivalent to information including the detection data indicating the state of the two-dimensional region.

The detection unit 31 is a camera that acquires video data of the detection region B1 as the above-described detection data. The detection unit 31 includes a detection port (specifically, camera lens unit) 31a that receives light from the detection region B1, and an imaging unit 31b that converts a video formed via the detection port 31a into data. The detection unit 31 is not limited to a camera, and can be changed to various configurations such as a LiDAR scanner and an ultrasonic scanner in which the state of the detection region B1 to be detected can be detected by receiving light or sound waves via the detection port. In a case where the detection unit directly receives light or sound waves with no lens and the like, the detection unit itself also serves as a detection port. Hereinafter, while description will be provided while the detection data acquired by the detection unit 31 is referred to as video data, in a case where the detection unit 31 is other configurations such as a two-dimensional scanner, the following video data may be replaced with detection data.

As shown in FIG. 1A, the detection unit 31 is attached to, for example, a frame 12f of the rotating platform 12. The detection unit 31 may be attached to the frame 12f via a stay or the like. A position of the detection unit 31 is not limited to the example of FIG. 1A, and may be disposed, for example, at a position higher than a rotation center axis of the drum 161 or may be attached to the mast 15 or other locations via a stay or the like.

The control device 33 is a computer that executes data processing and signal processing according to programs. The control device 33 determines the state of the drum 161 based on the video data of the detection unit 31. The state of the drum 161 is the number of layers, the number of rows, randomness, and the like of the rope W1 wound around the drum 161. From such a state, determination about whether or not the rope W1 reaches an unwinding limit (for example, a first layer and a third row) or determination about whether or not an abnormality (randomness of threshold abnormality) occurs in winding of the rope W1 can be performed. The number of layers means the number of steps in which the rope W1 overlaps in the radial direction of the drum 161, and the number of rows means the number of rows in which the rope W1 is arranged in an axial direction of the drum 161 in the same layer.

The control device 33 determines the state of the drum 161 by executing pattern recognition processing based on the video data of the detection unit 31 and training data. The control device 33 may include a machine learning model trained in advance based on training data, and may be configured such that a determination result is output by inputting video data to the machine learning model.

The control device 33 may output the determination result to a display 171 of the cab 17 or a terminal carried with an administrator or a worker and may transmit the state of the drum 161 to the operator, the administrator, or the worker. The control device 33 may send the determination result to a server device 800 of a management room or a cloud separated from the crane 1. Then, the control device 33 or the server device may record the determination result as log data d1 in a storage device 34, and may use the determination result for various kinds of control such as performing determination about whether or not to give a warning based on the determination result.

### Detection Region B1 by Detection Unit

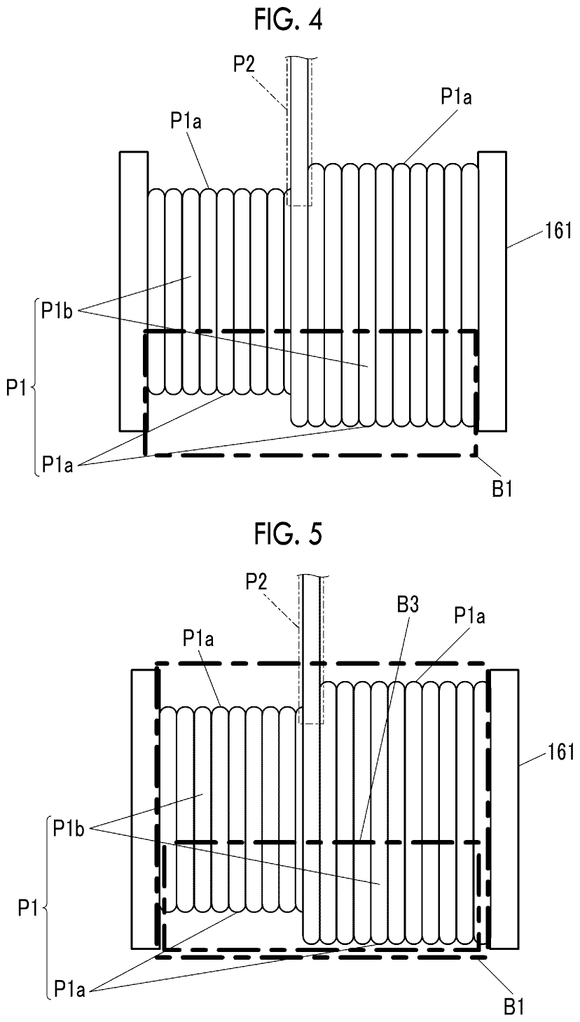

FIG. 4 is a diagram showing the detection region B1 by the detection unit (camera) 31 of Embodiment 1. In Embodiment 1, the detection region B1 that is detected by the detection unit 31 is set to a region including the wound rope portion P1 without including a portion excluding the unwound rope root portion P2a from the unwound rope portion P2. As a more preferred form, the detection region B1 of Embodiment 1 is set to a region where the ridge portion P1a not intersecting the unwound rope portion P2 is positioned. Preferably, the detection region B1 may be set to a region where the unwound rope root portion P2a is further not included. The detection region B1 may be set to a region on an opposite side to the unwound rope root portion P2a out of the wound rope portion P1, that is, a region where the unwound rope root portion P2a is unable to be detected from the detection unit 31.

The detection region B1 of the detection unit 31 can be specified from an angle of view of the detection unit 31 and the disposition of the detection unit 31. In a case where the detection unit 31 is a two-dimensional scanner, the detection region B1 can be specified from a scanning direction of the detection unit 31 and the disposition of the detection unit 31.

As described above, with the monitoring device 30 of Embodiment 1, the detection unit 31 acquires the video data indicating the state of the two-dimensional detection region B1 of the rope W1 wound around the drum 161. As the rope W1 shown by a solid line and an imaginary line in FIG. 1A, when a derricking angle of the boom 13 is different, an extension direction of the rope W1 is different, and a position separated from the wound rope portion P1 is different in a circumferential direction of the drum 161. The unwound rope portion P2 may be shaken due to the vibration of the rope W1. That is, the state of the unwound rope portion P2 is likely to be changed. The position of the unwound rope portion P2 is changed with a change of derricking of the boom 13. Accordingly, in Embodiment 1, the detection region B1 of the detection unit 31 is set to a region not including the unwound rope portion P2. With such a configuration, the unwound rope portion P2 of which the state is likely to be changed due to disturbance is not included in the video data acquired by the detection unit 31, and as a result, it is possible to exclude variation due to disturbance from the video data. Therefore, the determination accuracy of the state of the drum 161 based on the video data is improved, and the state of the drum 161 can be monitored with high accuracy. A change in state of the unwound rope root portion P2a out of the unwound rope portion P2 is very small. Accordingly, the unwound rope root portion P2a may be included in the detection region B1. Also in this case, the determination accuracy of the state of the drum 161 based on the video data is improved, and the state of the drum 161 can be monitored with high accuracy.

With the monitoring device 30 of Embodiment 1, the detection region B1 of the detection unit 31 is set to a region including the ridge portion P1a where the unwound rope portion P2 is not positioned. A difference in the number of layers and a difference in the number of rows of the rope W1 wound around the drum 161 are more clearly represented in the video data of the ridge portion P1a. Therefore, with the above-described setting, the determination accuracy of the state of the drum 161 is more improved, and the state of the drum 161 can be monitored with higher accuracy.

### Embodiment 2

In a monitoring device 30 of Embodiment 2, a detection region B2 to be detected by the detection unit 31 and a part of processing in the control device 33 are different, and other configurations are similar to the configurations in Embodiment 1. Hereinafter, different features will be described in detail.

FIG. 5 is a diagram showing the detection region B2 by the detection unit (camera) 31 of Embodiment 2. As shown in FIG. 5, a two-dimensional region (hereinafter, written as a detection region B2) to be detected by the detection unit 31 of Embodiment 2 is set to a region including the wound rope portion P1 and the unwound rope portion P2. As a more preferred form, the detection region B2 is set to a region including the ridge portion P1a on a side on which the unwound rope portion P2 is not positioned.

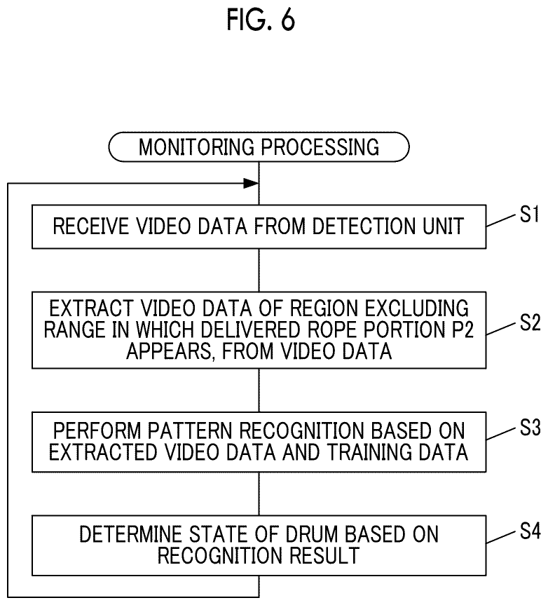

FIG. 6 is a flowchart showing a procedure of monitoring processing that is executed by a control device 33 of Embodiment 2. The control device 33 executes the monitoring processing in the procedure of FIGS. 7A and 7B. That is, when video data is received from the detection unit 31 (Step S1), video data of a region B3 (see FIG. 5) excluding a portion (that is, a portion in which the unwound rope portion P2 appears) indicating the state of the unwound rope portion P2 from the video data is extracted (Step S2).

In Step S2, preferably, the control device 33 extracts video data of the region B3 excluding a range in which the unwound rope portion P2 is likely to appear while the rope W1 is being wound, as well as this moment. More preferably, the region B3 to be extracted may be set to a region including the ridge portion P1a on a side on which the unwound rope portion P2 is not positioned.

Then, the control device 33 executes pattern recognition processing similar to Embodiment 1 based on the video data extracted in Step S2 (Step S3). Then, the control device 33 determines the state of the drum 161 based on a recognition result of Step S3 (Step S4). In the monitoring processing, the control device 33 repeatedly executes the processing of Steps S1 to S4.

As described above, with the monitoring device 30 of Embodiment 2, the control device 33 determines the state of the drum 161 based on the video data excluding the portion indicating the state of the unwound rope portion P2 out of the video data of the rope W1 wound around the drum 161. Therefore, the unwound rope portion P2 of which the state is likely to be changed due to disturbance is not included in the video data for use in the determination of the state, and as a result, it is possible to exclude variation due to disturbance from the above-described video data. Therefore, the determination accuracy of the state of the drum 161 based on the video data is improved, and the state of the drum 161 can be monitored with high accuracy.

With the monitoring device 30 of Embodiment 2, the region B3 of the video data extracted by the control device 33 is set to the region including the ridge portion P1a on the side on which the unwound rope portion P2 is not positioned. A difference in the number of layers and a difference in the number of rows of the rope W1 wound around the drum 161 are more clearly represented in the video data of the ridge portion P1a. Therefore, with the above-described setting, the determination accuracy of the state of the drum 161 is more improved, and the state of the drum 161 can be monitored with higher accuracy.

### Embodiment 3

In a crane 1 and a monitoring device 30 of Embodiment 3, the disposition of the detection unit 31 is different, and other configurations are similar to the configurations in Embodiments 1 and 2.

FIG. 7A is a diagram showing an example of disposition and a direction of the detection unit 31 in Embodiment 3. In Embodiment 3, as shown in FIG. 7A, the detection port (for example, camera lens) 31a of the detection unit 31 is disposed on a rear side with respect to the center of the drum 161 and on a lower side respect to the center (that is, a horizontal plane H0 passing through the center) of the drum 161. Here, a direction in which an end portion (an end portion on a side on which the rope W1 is unwound) of the unwound rope portion P2 is fixed (for example, fixed to a pulley of a boom tip portion, out of a horizontal direction is set as the front side.

In a right-left direction, the detection port 31a is disposed at a position overlapping the drum 161 when viewed from a direction perpendicular to the rotation axis A1 of the drum 161.

The direction of the detection port 31a is set as follows. The direction of the detection port 31a means a direction from the detection port 31a such as a center of an angle of view of the camera toward a center of a region to be detected. As shown in FIG. 7A, an elevation angle direction J1 in which the detection port 31a is directed is substantially a direction toward the rotation axis A1 of the drum 161. The elevation angle direction J1 in which the detection port 31a is directed may be a direction closer to the lower ridge portion P1a than the rotation axis A1.

The horizontal direction in which the detection port 31a is directed may be set such that the total width of the wound rope portion P1 is included in the detection region, such as a direction toward the center of the drum 161.

With such disposition and direction, the video data of the two-dimensional region of the drum 161 not including the unwound rope portion P2 can be easily acquired by the detection unit 31. In the video data acquired by the detection unit 31, the ridge portion P1a positioned on the lower side of the drum 161 is included. Therefore, the detection unit 31 can acquire video data of the ridge portion P1a with less disturbance elements such as entering of natural light such as sunlight or shadow. Accordingly, it is possible to reduce variation due to disturbance from the video data of the ridge portion P1a. Therefore, with the monitoring device 30 of Embodiment 3, the determination accuracy of the state of the drum 161 based on the video data is more improved, and the state of the drum 161 can be monitored with high accuracy.

As shown in FIG. 7A, the detection port 31a may be disposed at a position higher than a lower end of the flange portion 161b. With the disposition, a space where the detection unit 31 is disposed is easily secured. The detection port 31a may be disposed at a position lower than the lower end of the flange portion 161b.

### Embodiment 4

In a crane 1 and a monitoring device 30 of Embodiment 4, the disposition of the detection unit 31 is different, and other configurations are similar to the configurations in Embodiment 2. Hereinafter, different features will be described in detail.

FIG. 7B is a diagram showing an example of disposition and a direction of the detection unit 31 in Embodiment 4. The monitoring device 30 of Embodiment 4 monitors the winch 16A in which the rope W1 is unwound from the lower side of the drum 161.

In Embodiment 4, as shown in FIG. 7B, the detection port 31a of the detection unit 31 is disposed on a front side with respect to the drum 161 and on a lower side with respect to the horizontal plane H0 passing through the center of the drum 161. The detection port 31a is disposed at a position lower than the lower end of the flange portion 161b. In the right-left direction, the detection port 31a of the detection unit 31 is disposed at a position overlapping the drum 161 when viewed from a direction perpendicular to the axial direction of the drum 161.

As shown in FIG. 7B, an elevation angle direction J2 in which the detection port 31a is directed is substantially a direction toward the rotation axis A1 of the drum 161. The elevation angle direction J2 in which the detection port 31a is directed may be a direction closer to the lower ridge portion P1a of the drum 161 than the rotation axis A1. The horizontal direction in which the detection port 31a is directed may be set such that the total width of the wound rope portion P1 is included in the detection region, such as a direction toward the center of the drum 161.

With such disposition and direction, in the video data acquired by the detection unit 31, video data of the wound rope portion P1 included in a lower half of the drum 161 is included. In the video data, video data of the ridge portion P1a included in the lower half of the drum 161 is included. Such video data is video data with less disturbance element such as natural light or shadow. Therefore, with the monitoring device 30 of Embodiment 4, the determination accuracy of the state of the drum 161 based on the video data is more improved, and the state of the drum 161 can be monitored with high accuracy.

### Embodiment 5

A crane 1 and a monitoring device 30 of Embodiment 5 have a difference in that a background wall 32 is provided, and other configurations are similar to the configurations in Embodiments 1 to 4. Hereinafter, different features will be described in detail.

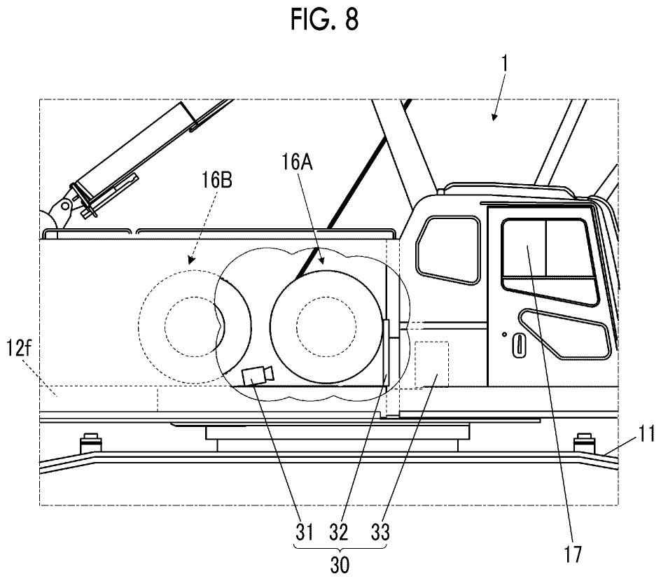

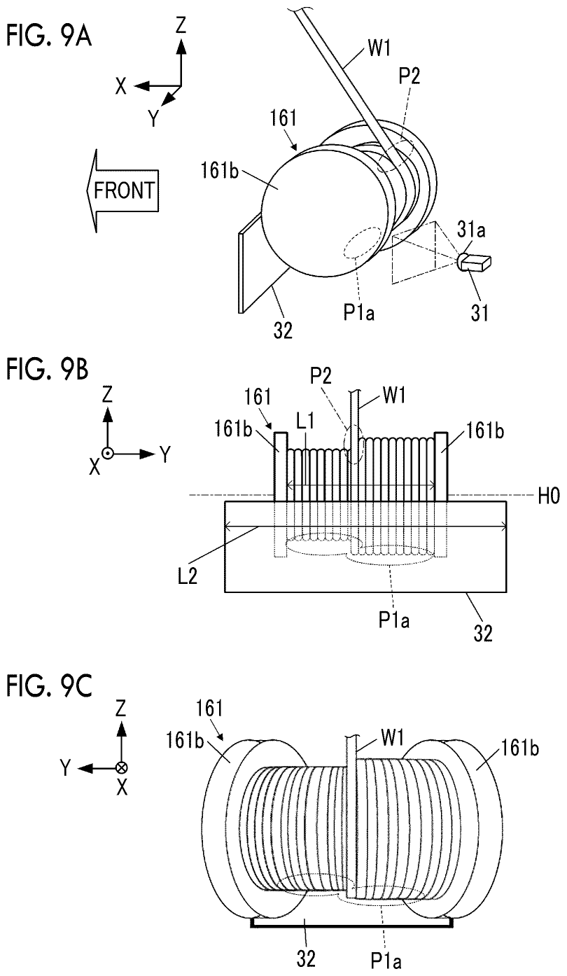

FIG. 8 is a partially broken enlarged view of a crane 1 in which a monitoring device 30 of Embodiment 5 is mounted. FIG. 8 shows the periphery of the winch 16A by virtual breaking. FIGS. 9A to 9C are diagrams showing disposition of a detection unit and a background wall of Embodiment 5, FIG. 9A is a perspective view, FIG. 9B is a rear view when the drum is viewed from the rear side, and FIG. 9C shows an example of a detected image (video) of the detection unit (camera). The monitoring device 30 of Embodiment 5 further includes a background wall 32.

The background wall 32 is a wall that becomes the background of the ridge portion P1a when viewed in a direction in which the detection port 31a is directed, from the detection port 31a of the detection unit 31. The background wall 32 is disposed on an opposite side to the detection port 31a across the ridge portion P1a where the unwound rope portion P2 is not positioned, in a direction facing the detection port 31a of the detection unit 31. That is, the ridge portion P1a where the unwound rope portion P2 is not positioned is positioned between the background wall 32 and the detection port 31a.

The background wall 32 has a reflection characteristic that is easily distinguished from the rope W1. As the reflection characteristic, when the detection unit 31 is a camera, and the detection data is video data, a color easily distinguished from the rope W1, an antiglare characteristic with less reflection, and/or the like can be applied. When the detection unit 31 is a LiDAR scanner, and the detection data is two-dimensional scan data, a characteristic of diffusely reflecting rays or the like can be applied as the above-described reflection characteristic.

The background wall 32 has, for example, a flat plate shape, and is attached to the frame 12f of the rotating platform 12 as shown in FIG. 8. The background wall 32 may be attached to the frame 12f via a stay or the like. The background wall 32 is disposed outward in a radial direction with respect to the flange portion 161b of the drum 161. The above-described radial direction means the radial direction of the drum 161.

The background wall 32 has a flat plate shape, and is disposed outward in the radial direction with respect to the flange portion 161b of the drum 161, so that an attachment space of the background wall 32 is easily secured, and the background wall 32 is easily attached. Preferably, the background wall 32 may be disposed vertically such that a wall surface follows a vertical direction. With the direction, the attachment space of the background wall 32 is more easily secured, and the background wall 32 is more easily attached. Further preferably, the background wall 32 may be positioned on a lower side with respect to the horizontal plane H0 passing through the center of the drum 161. With the disposition, the attachment space of the background wall 32 is more easily secured, and the background wall 32 is more easily attached. When the detection unit 31 detects (specifically, captures) the state of the lower ridge portion P1a of the wound rope portion P1, the background wall 32 becomes the background of the ridge portion P1a, and it is possible to reduce confusion of the background and the ridge portion P1a in the video data.

The background wall 32 is formed to have a width dimension L2 wider than a width dimension L1 of the body portion 161a of the drum 161 in an axial direction. The axial direction means the axial direction of the drum 161.

When the background wall 32 has a flat plate shape, and is disposed outward in the radial direction with respect to the flange portion 161b of the drum 161, when viewed from the detection port 31a of the detection unit 31, the background wall 32 looks smaller than the ridge portion P1a by the action of the law of perspective. For this reason, when the width of the background wall 32 is set to be the same as that of the body portion 161a of the drum 161, the entire background of the ridge portion P1a is not occupied by the background wall 32. In contrast, since the background wall 32 of the present embodiment is wider than the body portion 161a of the drum 161, as shown in FIG. 9C, it is possible to increase a ratio at which the background wall 32 occupies the background of the ridge portion P1a in the video data acquired by the detection unit 31.

As described above, with the crane 1 and the monitoring device 30 of Embodiment 5, the background wall 32 is provided, so that confusion of the ridge portion P1a and the background in the video data is reduced, and video data in which the state of the ridge portion P1a is clearly shown can be acquired. Therefore, the control device 33 can more accurately determine the state of the drum 161 based on the video data.

### Embodiment 6

In a crane 1 and a monitoring device 30 of Embodiment 6, a shape and disposition of a background wall 32A are different, and other configurations are similar to the configurations of Embodiment 5. Hereinafter, different features will be described in detail.

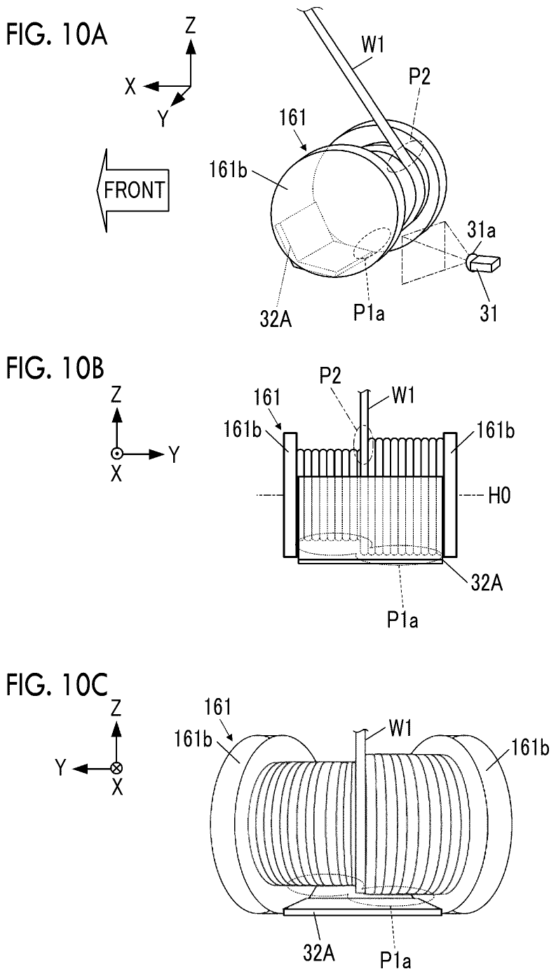

FIGS. 10A to 10C are diagrams showing disposition of a detection unit and a background wall of Embodiment 6, FIG. 10A is a perspective view, FIG. 10B is a rear view when the drum is viewed from the rear side, and FIG. 10C shows an example of a detected image of the detection unit (camera).

The monitoring device 30 of Embodiment 6 includes the background wall 32A that becomes the background of the ridge portion P1a when viewed in a direction in which the detection port 31a is directed, from the detection port 31a of the detection unit 31. The background wall 32A is disposed on an opposite side to the detection port 31a across the ridge portion P1a where the unwound rope portion P2 is not positioned. That is, the ridge portion P1a where the unwound rope portion P2 is not positioned is positioned between the background wall 32A and the detection port 31a.

The background wall 32A has a reflection characteristic that is easily distinguished from the rope W1, similarly to the background wall 32 of Embodiment 5.

The background wall 32A has a plate shape having a curve, and is attached to the frame 12f (see FIG. 8) of the rotating platform 12. The background wall 32A may be attached to the frame 12f via a stay. At least a part of the background wall 32A is disposed inward in a radial direction with respect to an outer periphery of the flange portion 161b of the drum 161. The radial direction means the radial direction of the drum 161. The curve of the background wall 32A is a curve in a direction along the outer periphery of the drum 161. The curve may be a gently sloping curve, may be a curve having an angle such as a bend, or may be a combined curve thereof.

The background wall 32A has a curve, and at least a part thereof is positioned inward in the radial direction with respect to the outer periphery of the drum 161, so that a disposition space of the background wall 32A can be easily secured. The action that the background wall 32A looks smaller than the ridge portion P1a by the law of perspective is reduced, and as shown in FIG. 10C, it is possible to increase a ratio that the background wall 32A occupies the background of the ridge portion P1a in the video data acquired by the detection unit 31.

As described above, with the crane 1 and the monitoring device 30 of Embodiment 6, the background wall 32A is provided, so that confusion of the ridge portion P1a and the background in the video data is reduced, and video data in which the state of the ridge portion P1a is clearly shown can be acquired. Therefore, the control device 33 can more accurately determine the state of the drum 161 based on the video data.

Each embodiment of the present invention has been described above. It should be noted that the present invention is not limited to the above-described embodiments. For example, a configuration has been described in which the monitoring device 30 of the above-described embodiments monitors the state of the drum 161 of each of the winches 16A to 16C mounted in the rotating platform 12. However, a drum of a winch to be monitored in the monitoring device according to the present invention is not limited thereto. For example, a monitoring device according to the present invention may be used to similarly monitor a state of a drum of a winch provided in the boom. A configuration may be made in which the monitoring device according to the present invention monitors a state of a drum of a winch mounted in a working machine other than a crane.

In the above-described embodiments, an example of a crane in which the monitoring device according to the present invention is mounted is a crawler crane. However, the present invention can be applied to any cranes such as a tower crane, an overhead traveling crane, a jib crane, a level luffing crane, a stacker crane, a portal crane, and an unloader, in addition to other mobile cranes such as a wheel crane, a truck crane, a rough terrain crane, and an all-terrain crane. The crane according to the present invention is not limited to a crane including a suspending tool, and a crane that suspends an attachment such as a magnet or an earth drill bucket is also within the scope of application of the present invention. The detailed parts described in the embodiments can be changed as appropriate without departing from the concept of the present invention.

It should be understood that the invention is not limited to the above-described embodiment, but may be modified into various forms on the basis of the spirit of the invention. Additionally, the modifications are included in the scope of the invention.

What is claimed is:

1. A winch monitoring device that monitors a state of a drum around which a rope is wound, the winch monitoring device comprising:
a detection unit configured to acquire detection data indicating a state of a two-dimensional region in the rope wound around the drum,
wherein, when a portion out of the rope wound around the drum is referred to as a wound rope portion, a portion that is separated from the wound rope portion and extends outward from the drum is referred to as an unwound rope portion, and a portion having a distance from the wound rope portion within a diameter of the rope out of the unwound rope portion is referred to as an unwound rope root portion, the two-dimensional region is set to a region not including a portion excluding the unwound rope root portion from the unwound rope portion.

2. The winch monitoring device according to claim 1, further comprising:
a control device configured to determine the state of the drum based on the detection data acquired by the detection unit; and
a storage device configured to record a determination result of the control device as log data.

3. The winch monitoring device according to claim 2,
wherein the control device determines the state of the drum by executing pattern recognition processing based on video data of the detection unit and training data.

4. The winch monitoring device according to claim 3,
wherein the state of the drum is determined with the number of layers, the number of rows, and randomness of the rope wound around the drum as a reference.

5. The winch monitoring device according to claim 1,
wherein the detection unit includes a detection port configured to receive light from a detection region, and an imaging unit configured to convert a video formed via the detection port into data.

6. The winch monitoring device according to claim 5,
wherein the detection unit is a camera, and the detection port configured to receive light from the detection region is a camera lens unit.

7. The winch monitoring device according to claim 1,
wherein the two-dimensional region is set to a region not including the unwound rope portion at all.

8. The winch monitoring device according to claim 7,
wherein the two-dimensional region is set to a region on an opposite side to the unwound rope root portion out of the wound rope portion.

9. The winch monitoring device according to claim 1,
wherein the two-dimensional region is set to a region including the wound rope portion and the unwound rope portion.

10. The winch monitoring device according to claim 9,
wherein the two-dimensional region is a detection region, and the detection region is set to a region including a ridge portion on a side where the unwound rope portion is not positioned.

11. A winch monitoring device that monitors a state of a drum around which a rope is wound, the winch monitoring device comprising:
a detection unit configured to acquire detection data indicating a state of the rope wound around the drum; and
a control device configured to determine, when a portion out of the rope wound around the drum is referred to as a wound rope portion, and a portion that is separated from the wound rope portion and extends outward from the drum is referred to as an unwound rope portion, the state of the drum based on detection data excluding a portion indicating a state of the unwound rope portion out of the detection data.

12. The winch monitoring device according to claim 1,
wherein the two-dimensional region includes a ridge portion where the unwound rope portion is not positioned, out of a ridge portion of the rope wound around the drum.

13. The winch monitoring device according to claim 11,
wherein the control device performs determination based on the detection data indicating a state of a ridge portion where the unwound rope portion is not positioned, out of a ridge portion of the rope wound around the drum.

14. The winch monitoring device according to claim 1,
wherein the detection unit is configured to receive light or a sound wave via a detection port to detect a state of an object, and
the detection port is disposed on a lower side with respect to a center of the drum.

15. The winch monitoring device according to claim 14,
wherein, with a direction in which an end portion of the unwound rope portion is fixed set as a front side,
the detection port is disposed on a rear side with respect to the center of the drum.

16. The winch monitoring device according to claim 12,
wherein the detection unit is configured to receive light or a sound wave via a detection port to detect a state of an object,
the winch monitoring device further comprises a background wall, and
the ridge portion where the unwound rope portion is not positioned is positioned between the detection port and the background wall.

17. The winch monitoring device according to claim 1,
wherein the rope changes a suspending position of a suspending tool of a crane.

18. A crane comprising:
the winch monitoring device according to claim 1.
